(19) United States
(12) Patent Application Publication
(10) Pub. No.: US 2006/0010705 A1
(43) Pub. Date: Jan. 19, 2006

(54) Baseball diamond measuring device

(76) Inventor: John Dettellis, Lyndhurst, NJ (US)

Correspondence Address: Donald W. Meeker;Patent Agent, 924 East Ocean Front #E, Newport Beach, CA, 92661, US

(21) Appl. No.: 10/894,096

(22) Filed: Jul. 19, 2004

(51) Int. Cl. G01B 3/10

(52) U.S. Cl. 33/756

(57) ABSTRACT

A hand-held measuring device shaped like home plate holds a reel of line having color coded markings representing distances related to the dimensions of a variety of different sizes of baseball or softball diamonds. An end ring at the end of the line and an anchoring ring at the back of the housing can be staked to the ground. The device allows for a single person to create a competition or practice field with the proper dimensions of a baseball or softball diamond for various sizes of professional or amateur fields.

### BACKGROUND OF THE INVENTION

1. Field of the Invention

The present invention relates to measuring devices and particularly to a hand-held tape measure type device shaped like home plate, which holds a reel of line marked with specific distances related to a baseball diamond and preferably color coded, which device also has an end ring at the end of the line and an anchoring ring at the back of the housing for staking to the ground.

2. Description of the Prior Art

In the very popular games of baseball and softball, bases are used to mark three of the four corners of the baseball diamond around which the batter must run after hitting the ball in an effort to reach home plate on the fourth corner. Conventionally, the bases are made from canvas material with foam or other soft filling. Typically, the bases are held in position by steel pegs, which are driven into the ground and then strapped to the bases. The bases and home plate are laid out at specific distances from one another for Major League dimensions, Little League and Softball dimensions.

In regulation baseball, the distance from home plate to first base is 90 feet and is measured along the right side of the diamond. Similarly, the distance from home plate to third base is 90 feet and is measured along the left side of the diamond. Along the central portion of the diamond, a distance of 60 feet 6 inches is measured for the pitcher's rubber and 127 feet 3 inches for second base, from home plate. Naturally, the dimensions will vary according to which type of ball game is going to be played. For example, in Little League, the distance from home plate to first or third base is sixty feet, forty-six feet to the pitcher's rubber and eighty-four feet ten inches to second base.

In competitive play it is very important to position home plate, the three bases and the pitcher's rubber accurately to assure consistent results and fair competition. It is equally important in practice to lay out accurate distances from the pitcher's rubber to home plate for a pitcher, catcher, or batter practicing, and between home plate and the bases for runners practicing especially in practicing stealing bases, and between home plate and the bases and the pitcher's rubber in practice games to insure proper performance in the game by practicing on the same size field.

Laying out a baseball or softball diamond with home plate, the three bases, and pitcher's rubber for playing competitively or practicing often takes considerable time and suffers greatly in accuracy if the distances area measured by pacing them out or just “eyeballing”. Even using a tape measure requires two people and an accurate reading of the tape. Prior art devices fail to provide a device which is easy-to-use and foolproof to measure and lay out a baseball diamond or any portion thereof accurately and quickly, and especially fail to provide such a device which may be used accurately and quickly by a singly individual.

U.S. Pat. No. 3,668,781, issued Jun. 13, 1972 to Teter, relates to a device for laying out a baseball diamond. The device includes a flat five-sided plate on which three fixed position tape measures have been placed at predetermined angles. The two outer tapes are used to determine the location of first and third bases whereas the center tape can indicate the location of second base and the pitching mound. All tapes are marked with specific diamond layout measurements.

U.S. Pat. No. 4,267,637, issued May 19, 1981 to Paull, is for a device useful for setting up a baseball diamond, which comprises a central prong and two secondary prongs. The prongs are positioned in such a manner so as to facilitate the positioning of first, second, and third bases as well as the pitcher's rubber on a baseball diamond. A graduated tape measure may be mounted at the point that pivots the central prong and the secondary prongs. The tape can then be easily used to mark off the appropriate distances.

U.S. Pat. No. 5,371,949, issued Dec. 13, 1994 to Delaurier, provides a method and tape construction for laying out a baseball diamond. A reel is provided that is dedicated to the layout of a baseball diamond, which includes a tape with an inner end, reeled onto a reel body and an outer end attached to the reel body to form a loop of the tape. The loop has a length 2x+. Sqroot.2x and has a first base marking at a distance x from the outer end, a second base marking at a distance 2x from the outer end, a third base marking at a distance x+.sqroot.2x from the outer end and a pitcher's plate marking at a distance of y from the inner end. X is equal to the required distance between bases. Y is equal to the distance of the pitcher's plate from home base. The loop is pulled out into a first triangle from first base to second base and back to home plate and then in a second triangle from home plate to first base and to third base to accurately lay out the positions of pegs.

U.S. Pat. No. 4,160,324, issued Jul. 10, 1979 to Dunn, shows a tool for quickly and easily laying out all of the components of a baseball diamond. The tool consists of an elongated tape, or equivalent flexible object, which has a row of openings along its length that are properly spaced apart and from its end, each opening being identified. The tape is adaptable to be wound up upon a reel, for convenient carrying by a person.

U.S. Pat. No. 4,162,789, issued Jul. 31, 1979 to Hollaway, claims a baseball base and installation apparatus, whereby the base has attached to the bottom surface thereof a post having a non-circular cross-section. The installation apparatus includes a brace member, an anchor member having a top socket portion and a bottom screw auger portion, the top socket portion having a hollow interior complementary to the configuration of the non-circular post, and the screw auger portion being a flat strip of metal formed into a helical configuration. The brace member has a non-circular lug portion of a configuration complementary to the interior of the top socket portion and a handle portion for rotating the lug portion. The lug portion is telescopically inserted into the socket portion; the handle is rotated to install the anchor member into the ground. After the anchor member has been installed into the ground the brace member is removed and the post of the base is telescopically inserted into the socket portion. The base and anchor assembly is intended for use with a measuring device, which includes a reel consisting of a flat H-shaped piece of metal or rigid material having a rectangular-shaped notch formed in each end thereof for storing and paying out a flexible measuring rope. An anchor pin is mounted on one end of the rope and a plurality of distance or measurement-indicating markers are attached to the rope and spaced throughout the length thereof. The markers are provided with distance indicia marked thereon, specifying the distance in feet from the pin to a particular marker. A plurality of these markers will be attached to the rope and will have indicia corresponding to the usual base separations used for the various age groups and sexes, and also will include markers corresponding to the distances from home plate to the pitcher's rubber for these age groups.

U.S. Pat. No. 6,141,880, issued Nov. 7, 2000 to Vircks, describes a tool for laying out a pattern of a measured size and orienting the pattern with respect to an exterior point of reference. A cord is provided having a plurality of anchoring points spaced along its length is arrayed to form the pattern. A direction-finding device orients the pattern formed by the cord to a point of reference exterior to the pattern. Anchoring devices anchor each anchoring point of the cord to a surface so that the cord is held to the surface in the shape of the pattern. The cord is attached to a spool, which stows the cord, anchoring devices, and direction-finding device when not deployed. An alternative embodiment is shown in which the device is used to layout a baseball diamond.

U.S. Pat. No. 5,280,921, issued Jan. 25, 1994 to Milburn, discloses a sporting field layout system, which comprises a cable used to mark lines on athletic fields having sections of tubing that locate the particular yard line to run chalk lines from one side of the field to the other. After use, the cable is rolled up on a cord reel for storage. The device could be used to mark baseball, softball, soccer and other fields with the number and spacing between tubing section being appropriately revised.

What is needed is a device for measuring and laying out a baseball diamond with easy to use color-coded pre-measured markings for the distances between home plate and the bases and the pitcher's rubber for various sizes of diamonds enabling a single person to mark out the diamond accurately, quickly and easily.

### SUMMARY OF THE INVENTION

An object of the present invention is to provide a device which may be pinned to the ground at each end for measuring and laying out a baseball diamond or any portion thereof with easy to use color coded pre-measured markings for the distances between home plate and the bases and the pitcher's rubber for various sizes of diamonds enabling a single person to mark out the diamond accurately, quickly and easily.

Another object of the present invention is to provide a baseball diamond-measuring device, which is a single unit with a hold-down ring on a casing, which may be secured to the ground or grasped for pulling out the line enabling a single person to roll out the marked tape from the casing to lie out the diamond.

One more object of the present invention is to provide a baseball diamond measuring and layout device that is relatively inexpensive to produce.

An additional object of the present invention is to provide a baseball measuring and layout device, which has a casing, shaped like home plate to indicate its usage.

A further object of the present invention is to provide a full swing handle with a convenient gripping knob on the top of the casing for reeling in the line.

An added object of the present invention is to provide a large flat surface on both sides of the casing for imprinting team names, logos, advertising and any other desired indicia.

An ensuing object of the present invention is it allows for quick instillation of a make shift baseball or softball fields or portions of fields, such as a home plate and pitcher's rubber for practice, of proper dimensions.

In brief, a hand held tape measure type device has a casing shaped like home plate which holds a reel of line (cord, string or tape) marked with specific distances related to a baseball diamond or softball diamond, preferably color coded markings. A ring at the back end of the home run shaped casing is spiked into the ground and the line is withdrawn from the casing and stretched out in the desired direction and the color coded markings used to set the locations of the bases and pitcher's rubber. An outer ring on the outer end of the line is useful in grasping the line to pull it and the outer ring may be spiked into the ground and the casing positioned to mark the locations.

The present invention has the ability to create Major League diamonds, Little League diamonds, and softball diamonds according to different positions and colors of the color-coded markings on the line. For competitive play, the present invention positions home plate, the three bases and the pitcher's rubber accurately to assure consistent results and fair competition. For practice the present invention may be used to lay out accurate distances from the pitcher's rubber to home plate for a pitcher, catcher, or batter practicing, and between home plate and the bases for runners practicing especially in practicing stealing bases, and between home plate and the bases and the pitcher's rubber in practice games to insure proper performance in the game by practicing on the same size field.

The intent of this tool is to give accurate measurements for makeshift practice fields where there are none. It also has the potential to keep down injuries on all players' arms due to the fact that there would not be players overthrowing longer than expected bases or give a sense of false security to bases that are shorter than they should be.

These diamonds take approximately 5 to 7 minutes to construct using the present invention.

An advantage of the present invention is to provide a device which a single person to mark out the diamond accurately, quickly and easily.

Another advantage of the present invention is to allow a single person to roll out the marked tape from the casing to lie out the diamond.

An additional advantage of the present invention is to provide a device, which is relatively inexpensive to produce.

One more advantage of the present invention is to provide a device that has a casing shaped like home plate to indicate its usage.

Yet another advantage the present invention is to provide a convenient gripping knob on for reeling in the line.

Still another advantage of the present invention is to provide a large flat surface for imprinting team names, logos, advertising and any other desired indicia.

A further advantage is that it allows for a quick and easy set up of a make shift field's or practice area's proper dimensions.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the present invention showing the casing shaped like home plate with a reel handle, printed indicia, and spiking ring and the line with an outer end ring for grasping or spiking;

FIG. 2 is a top plan view of the present invention of FIG. 1 showing the casing shaped like home plate with a reel handle, printed indicia, and spiking ring and the line with an outer end ring for grasping or spiking and color coded distance markings for measuring and marking the distances between the elements of the diamond;

FIG. 2A is a bottom plan view of the present invention of FIG. 1 showing the printed indicia on a backside of the casing opposite the handle side;

FIG. 3A is a plan view of the present invention of FIG. 1 in use laying out a baseball diamond measuring and marking out the distances between home plate and the pitcher's rubber and home plate and second base;

FIG. 3B is a plan view of the present invention of FIG. 1 in use laying out a baseball diamond measuring and marking out the distances between second base and first base;

FIG. 3C is a plan view of the present invention of FIG. 1 in use laying out a baseball diamond measuring and marking out the distances between second base and third base.

### BEST MODE FOR CARRYING OUT THE INVENTION

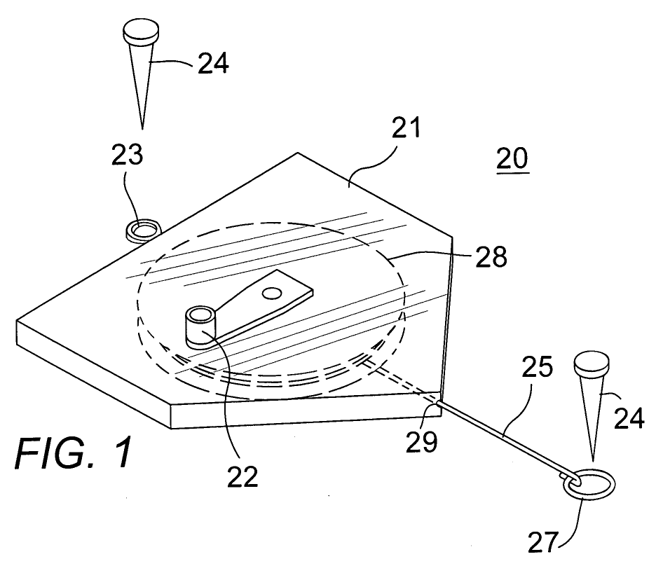

In FIGS. 1, 2 and 3, a baseball diamond-measuring device 20 is adapted for laying out the distances between elements of different sizes of infields 40 used in playing baseball and softball.

A measuring tool comprises a rigid flat casing 21 shaped like home plate with a ground spike-receiving ring 23 attached to and protruding from a center point of a rear edge of an exterior of the casing. The ground spike receiving ring 23 is adapted to receive a ground spike 24 enabling the casing to anchor to a ground surface within the interior of the casing is a rotatable reel 28 which contains a length of inelastic line 25 wound around the reel. The line extends through an opening 29 at the front point of the casing that communicates between the interior space and an exterior of the casing. A full circle rotatable handle 22 on the exterior of the casing is adapted for turning the reel 28 to reel in the line for storage of the line in the casing.

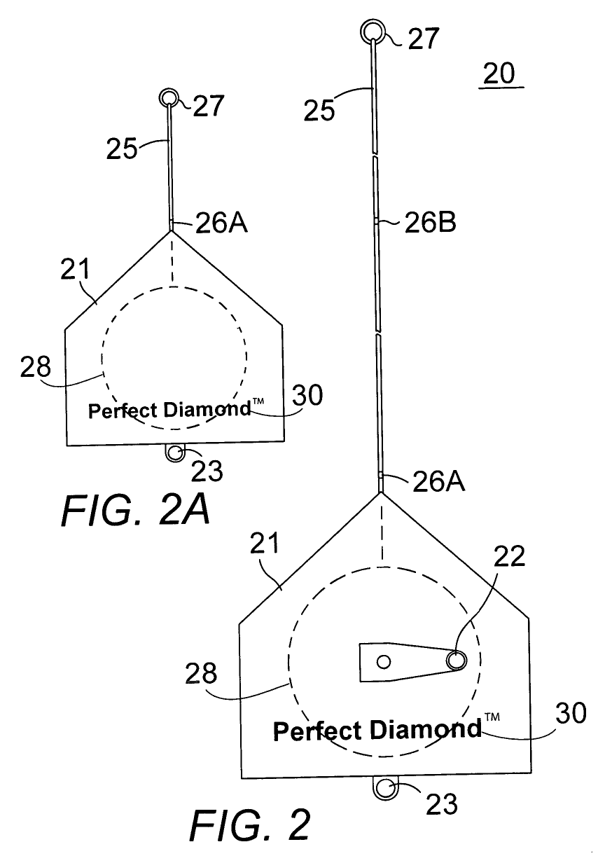

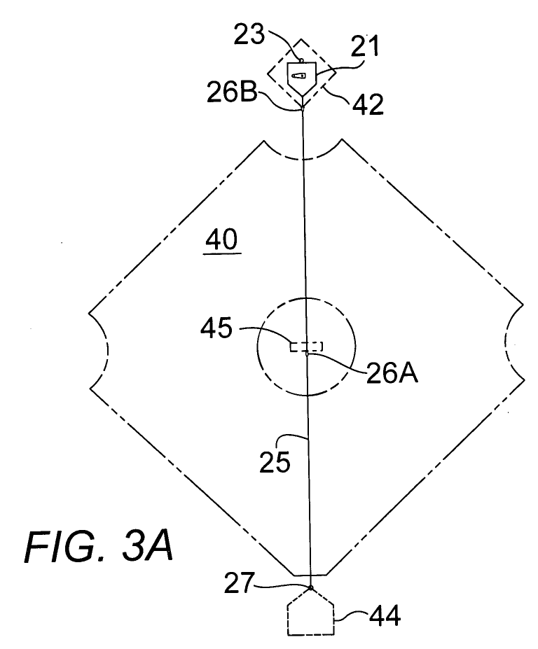

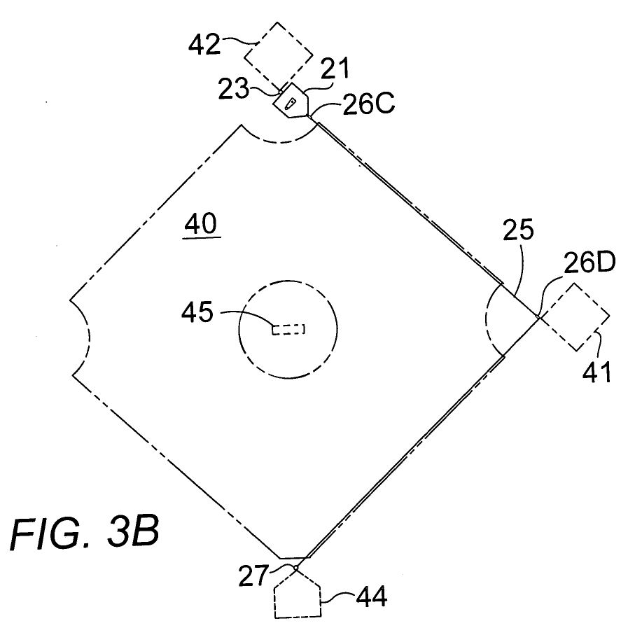

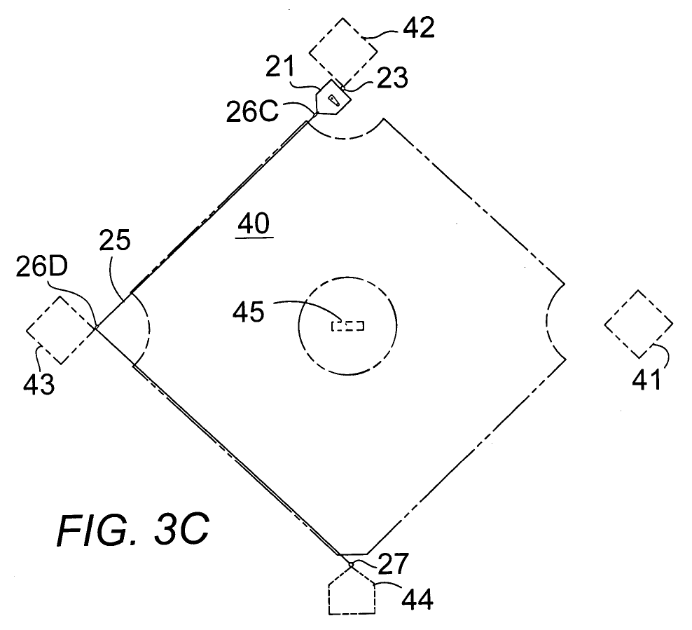

The line bears unique visual markers 26A, 26B, 26C and 26D (shown in FIGS. 2 and 3) spaced along the length of the line at specific intervals delineating specific distances between elements of an infield including home plate 44 and a pitcher's rubber 45 and the bases 41, 42, and 43 of standard fields for playing baseball and softball at different levels of play including a variety of professional and nonprofessional levels of playing baseball and softball. The visual markers 26A-26D are color coded for the distances between specific diamond elements being measured and can differentiate between the different distances between elements depending upon the types of playing fields being measured.

The outer ring 27 is adapted to be gripped by a user to withdraw a length of the line selected from a cord, a string, a tape, a wire, and a synthetic fiber and also adapted to be staked into the ground for carrying the casing 21 to reel out the line 25 in measuring. In FIG. 2 a front side of the casing having the handle 22 may have an external flat surface for bearing an indicia 30, such as a logo, team name, product name or advertising. In FIG. 2A, the backside of the casing 21 may also comprise an external flat surface thereon for bearing indicia 30.

In practice, in FIG. 3A, the outer end ring 27 is adapted to be grasped for pulling out the line 25 and for being spiked into the ground where home plate 44 would normally be placed. The user then holds the casing 21 in his/her hand and proceeds to move in the direction of the intended pitchers mound 45 and moving towards second base 42. Using a color-coded legend 26A, 26B, and 26C placed on the device, the user then locates the desired color on the line and marks the ground at the desired location, such as the pitcher's rubber 45 located by the marking 26A and second base 42 located by the marking 26B. Once second base 42 and the pitcher's rubber 45 are placed, the user has now created a straight and accurate line in the middle of the diamond.

In FIG. 3B, in order to get the first base 41 and third base 43 placements correct the user walks out past second base out to a distance on the line where the marking 26C indicates double the distance between bases. The user then spikes the spike receiving ring 23 on the back of the casing 21 at the second base placement, leaving the end ring 27 spiked into the position of home plate 44, and the user picks up the line 25 and walks out to approximately where first base 41 would be located holding the marking 26D which locates the distance between home plate 44 and first base 41 and at the same time indicates the distance between second base 42 and first base 41. The line is pulled tight holding the marking 26D and the marking is used to mark the ground to position first base 41, as shown in FIG. 3B.

The user then picks up the color coded line 25 holding the marking 26D and proceeds across the diamond to the proposed location of third base 43. When the line 25 is taught between home plate 44 and third base 43 and between second base 42 and third base 43, the ground is marked at the marking 26D to place third base 43, as shown in FIG. 3C.

This procedure will create a perfect square or “diamond” for the type and level of game intended to be played on the field.

The present invention has the ability to create Major League dimensions, Little League and softball Dimensions. Also just for pitchers and catchers, home to pitchers mound can be measured. The tool may be used to give accurate measurements for makeshift practice fields where there are none.

Two people or a single person for a fast and easy means of laying out a baseball or softball diamond or any elements of the diamond of the desired dimensions for the level of play may use the diamond-measuring device.

It is understood that the preceding description is given merely by way of illustration and not in limitation of the invention and that various modifications may be made thereto without departing from the spirit of the invention as claimed.

What is claimed is:

1. A baseball diamond measuring device for laying out the distances between elements of different sizes of infields used in playing baseball and softball, the device comprising:
A measuring tool comprising a rigid flat casing shaped like home plate, a ground spike receiving ring attached to and protruding from a center point of a rear edge of an exterior of the casing, the ground spike receiving ring adapted to be grasped for pulling out the line and also for being spiked or pinned onto the ground here through to anchor the casing to a ground surface, an interior space within the casing housing a rotatable reel, a length of inelastic line wound around the reel, an opening through a front point of the casing communicating between the interior space and an exterior of the casing, the opening adapted to admit the line therethrough, and a rotatable handle on an exterior of the casing adapted for turning the reel to reel in the line for storage of the line in the casing, the line bearing unique visual markers along the length of the line, the markers spaced at intervals delineating specific distances between elements of an infield including home plate and a pitcher's rubber and the bases of standard fields for playing baseball and softball at different levels of play including a variety of professional and nonprofessional levels of playing baseball and softball, the visual markers coded for the elements being measured and coded to differentiate between the different types of playing fields being measured, an outer ring attached to an outer end of the line, the outer ring adapted to be gripped by a user to withdraw a length of the line from the casing, the markers on the line adapted to be used to demark the length of line withdrawn for measuring distances between specific elements of any of a variety of different types of infields.

2. The device of claim 1 wherein the markers are color-coded.

3. The device of claim 1 wherein the markers are color-coded elements attached to the line.

4. The device of claim 1 wherein the markers are differently colored sections of the line.

5. The device of claim 1 wherein the line is a type of line selected from a cord, a string, a tape, a wire, and a synthetic fiber.

6. The device of claim 1 wherein the casing further comprises at least one external flat surface thereon for bearing indicia.
